(19) United States
(12) Patent Application Publication
(10) Pub. No.: US 2024/0378118 A1
(43) Pub. Date: Nov. 14, 2024

(54) MOBILE INTELLIGENT INDUSTRIAL DEVICE CLONING

(71) Applicant: Rockwell Automation Technologies, Inc., Mayfield Heights, OH (US)

(72) Inventors: Marius G. CHIS, Cambridge (CA); Scott D. DAY, Richfield, WI (US); David C. MAZUR, Grafton, WI (US); Jonathan A. MILLS, Mayfield Heights, OH (US)

(21) Appl. No.: 18/316,305

(22) Filed: May 12, 2023

(51) Int. Cl. G06F 11/14; G06F 16/23

(52) U.S. Cl. CPC G06F 11/1461; G06F 11/1456; G06F 16/2365; G06F 16/27; G06F 2201/84

(57) ABSTRACT

A method includes using a mobile device, obtaining first intelligent device information for backup of a first intelligent industrial device of an industrial system, using the mobile device, creating a backup of the first intelligent industrial device including a first device identity and a first device configuration based on the first intelligent device information, and using the mobile device, configuring a second intelligent industrial device as a clone of the first intelligent industrial device based on the backup.

### BACKGROUND INFORMATION

The subject matter disclosed herein relates to industrial systems and apparatus.

### BRIEF DESCRIPTION

In one aspect, a method includes, using a mobile device, obtaining first intelligent device information for backup of a first intelligent industrial device of an industrial system, using the mobile device, creating a backup of the first intelligent industrial device including a first device identity and a first device configuration based on the first intelligent device information, and using the mobile device, configuring a second intelligent industrial device as a clone of the first intelligent industrial device based on the backup.

In another aspect, a non-transitory computer readable medium has computer executable instructions which, when executed by a processor of a mobile device connected to an industrial network of an industrial system, cause the mobile device to obtain first intelligent device information for backup of a first intelligent industrial device of an industrial system, create a backup of the first intelligent industrial device including a first device identity and a first device configuration based on the first intelligent device information, and configure a second intelligent industrial device as a clone of the first intelligent industrial device based on the backup.

In a further aspect, a mobile device includes a memory that stores executable components, and a processor, operatively coupled to the memory and configured to execute the executable components. The executable components include a communications component that communicates with intelligent industrial devices of an industrial system, a backup component that creates a backup of a first intelligent industrial device including a first device identity and a first device configuration, a clone component that configures a second intelligent industrial device as a clone of the first intelligent industrial device based on the backup, and a conversion component that converts a description of functionality of the first intelligent industrial device to a second device configuration suitable for the second intelligent industrial device and configures the second intelligent industrial device based on the second device configuration.

### BRIEF DESCRIPTION OF THE DRAWINGS

FIG. 1 is a system diagram of an industrial system.

FIG. 1A is a schematic diagram of a human interface module of the industrial system.

FIG. 1B is a schematic diagram of a mobile device operatively coupled to the industrial system.

FIG. 2 is a flow diagram of a method.

### DETAILED DESCRIPTION

Referring now to the figures, several embodiments or implementations are hereinafter described in conjunction with the drawings, wherein like reference numerals are used to refer to like elements throughout, and various features are not necessarily drawn to scale.

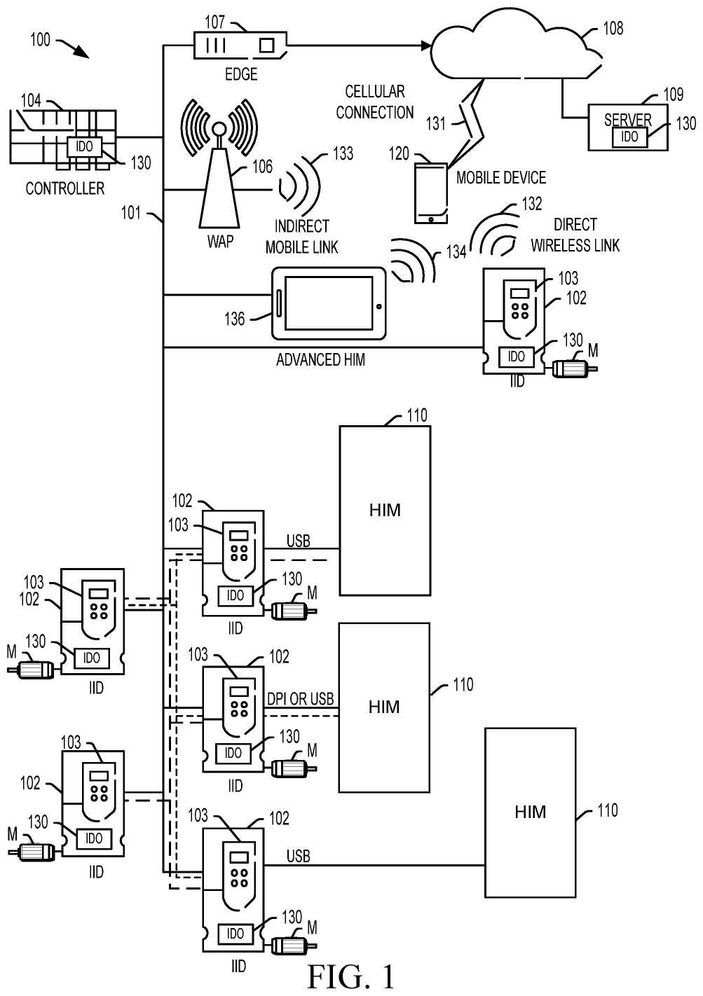

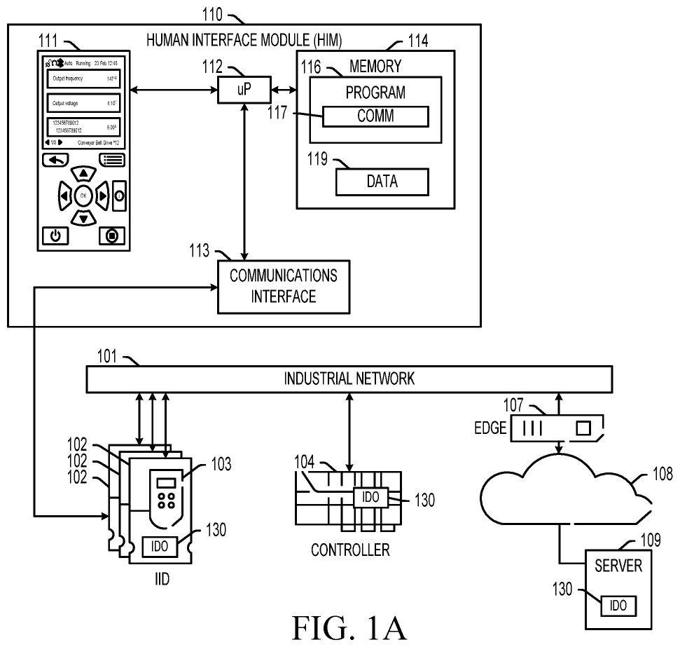

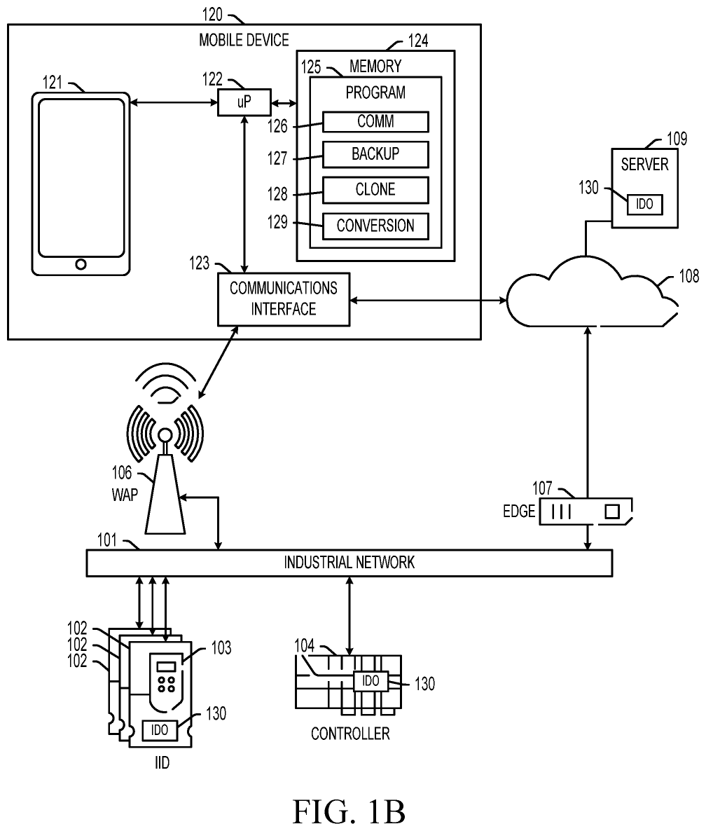

FIG. 1 shows an industrial system 100 having an industrial network 101 and intelligent industrial devices (IID) 102 (e.g., labeled IID in FIG. 1) operatively connected to the industrial network 101. The illustrated system 100 has various possible components, but the illustrated and described components are not all necessary for a given implementation and other system implementations can have more, fewer and/or different components depending on the application. The system 100 also includes one or more human interface modules 103 (also referred to as HIMs) operatively coupled to an associated one of the intelligent industrial devices 102 and/or to the industrial network 101. The industrial network 101 can be or include any suitable type and form of communications network with communications lines and equipment, wired and/or wireless, communications bridging equipment, etc., for example industrial Ethernet or Ethernet/IP, fieldbus compliant networks, etc., configured to support communications between connected devices and systems using one or more protocols, and may include bridges or adapters for interfacing devices communicating on different protocols. The intelligent industrial devices 102 can be any form or type of industrial control component or system, for example, motor drives operative to drive a motor load M as schematically illustrated in FIG. 1, power supplies, other types and forms of industrial control equipment, etc. The industrial system 100 may also include one or more controllers 104 (e.g., rack mounted modules programmable logic controllers (PLCs), I/O modules, etc.) operatively coupled to the industrial network 101, a wireless access point (WAP) 106 operatively coupled to the industrial network 101, and a network edge device 107 operatively coupled with the industrial network 101 to provide communications between the industrial network 101 and a cloud connection 108 to a server 109 and/or other external networks, components and/or systems (not shown). The industrial system 100 and the components thereof provide control and actuator functions to operate an industrial system, such as a manufacturing facility or machines thereof, such as conveyors, motors, valves, power supplies, etc., including operation of one or more connected or independent control loops implemented by processors (not shown) of one or more of the intelligent industrial devices 102, the controller 104, and/or of a remote system such as the cloud-based server 109. In certain implementations, one or more of the intelligent industrial devices 102, the controller 104, and/or the cloud-based server 109 include one or more respective device identity objects 130 (e.g., labelled “IDO” in FIG. 1) used to store identity data or information.

The industrial system 100 in one example also includes intelligent HIMs 110 operatively coupled to an associated one of the intelligent industrial devices 102 and/or to the industrial network 101. The HIMs 110 can include human-machine interface devices and systems, such as displays, keyboards or keypads, speakers, microphones, etc. FIG. 1A illustrates an example HIM 110 of the industrial system 100. FIG. 1 further illustrates a mobile device 120 that can be operatively coupled to the devices 102 and other components of the system 100 and to the industrial network 101 by various structures, for example, cellular or other wired or wireless connections to the industrial network 101 via the cloud connection 108 and the network edge device 107 (shown as an optional cellular connection 131 in FIG. 1), wired or wireless connections to one of the intelligent industrial devices 102 and/or to an associated HIM 103 (e.g., shown as a direct wireless link 132 in FIG. 1), a wireless connection via the WAP 106 (e.g., shown as an indirect mobile link 133 in FIG. 1), and/or a wireless connection 134 established between the mobile device 120 and an advanced HIM 136, such as a tablet device operatively coupled by wired or wireless communications to the industrial network 101 as shown in FIG. 1. FIG. 1B shows an example implementation of the mobile device 120 operatively coupled to the industrial system 100.

As shown in the example of FIG. 1A, the intelligent HIMs 110 include an operator or user interface 111, having a graphic and/or textual visual display and various keypad buttons to allow a user to interact with the HIM 110 and an associated one of the intelligent industrial devices 102, as well as a processor 112 operatively coupled with a communications interface 113 operatively coupled with the industrial network 101 and with an associated intelligent industrial device 102, as well as an electronic memory 114. The electronic memory 114 includes processor executable instructions to implement a program 116, including a communications component 117, as well as data storage 119. The program instructions 116 in one example implement the functions described herein. In operation, the HIM 110 communicates with one or more of the intelligent industrial devices 102 and/or associated local HIMs 103, as well as with the controller 104 and/or the cloud-based server 109 via the cloud connection 108 as schematically illustrated in FIG. 1A.

FIG. 1B illustrates an example implementation of the mobile device 120. The mobile device 120 can be any form of portable electronic device, such as a tablet, smart phone, smart watch, etc. The illustrated example mobile device 120 includes a user interface 121, such as a touchscreen allowing a user to interact with one or more apps or programs installed in the mobile device 120. The mobile device 120 includes a processor 122 operatively coupled with a communications interface 123. The communications interface 123 is operatively coupled with the industrial network 101 for wired or wireless communications there between. The processor 122 is operatively coupled to an electronic memory 124. The electronic memory 124 is a non-transitory computer readable medium that includes processor or computer executable instructions to implement a program 125, including a communications component 126 and a content component 128, as well as data storage (not shown). The computer executable program instructions 125 in one example implement an app to perform the functions described herein, and a user can download the app to the mobile device 120. In operation, execution of the program instructions of the communications component 126 by the mobile device 120 allows the mobile device 120 to communicate with one or more of the intelligent industrial devices 102 and/or associated local HIMs 103, as well as with the controller 104 and/or the cloud-based server 109 via the cloud connection 108 as schematically illustrated in FIG. 1A. The mobile device 120 in one implementation can communicate with the intelligent industrial devices 102 either directly (e.g., via Bluetooth) or by accessing the industrial network 101 through the WAP 106 and browsing for intelligent industrial devices 102. The cloud connection 108 in one example facilitates accessing data uploaded to the cloud by the intelligent industrial devices 102 via the edge device 107. The cloud connection 108 in one example does not allow the mobile device 120 to interact with intelligent industrial devices 102 directly, although not a strict requirement of all possible implementations. In the illustrated example, the mobile device 120 can communicate with the cloud-based server 109 either directly by cellular connection to the cloud connection 108 and/or through the industrial network 101 via the edge device 107. The industrial network 101 is configured to connect the mobile device 120 to the industrial system 100 and devices and components of the system 100. In operational execution by the processor 122, the communications component 126 communicates with intelligent industrial devices 102 of an industrial system 100, the backup component 127 creates and stores a backup of a first intelligent industrial device 102 of the industrial system 100 including a first device identity and a first device configuration. The clone component 128 configures a second intelligent industrial device 102 of the industrial system 100 as a clone of the first intelligent industrial device 102 based on the backup. In certain examples, the conversion component 129 converts a description of functionality of the first intelligent industrial device 102 to a second device configuration suitable for the second intelligent industrial device 102 and configures the second intelligent industrial device 102 based on the second device configuration.

The computer executable program instructions 125 in the electronic memory 124, when executed by the processor 122 of the mobile device 120, cause the mobile device 120 to communicate with one or more of the intelligent industrial devices 102 of the industrial system 100 (e.g., by execution of the communications component 126), create a backup of a first intelligent industrial device 102 including a first device identity and a first device configuration (e.g., by execution of the backup component 127), configure a second intelligent industrial device 102 as a clone of the first intelligent industrial device 102 based on the backup (e.g., by execution of the clone component 128), and convert a description of functionality of the first intelligent industrial device 102 to a second device configuration suitable for the second intelligent industrial device 102 and configures the second intelligent industrial device 102 based on the second device configuration (e.g., by execution of the conversion component 129). In one or more examples, the mobile device 120 is configured to present a common functional view of the first intelligent industrial device 102 as a high level functional definition to a user. In these or other example, the mobile device 120 is configured to store the high level functional definition. In these or other example, the mobile device 120 is configured to create a second intelligent industrial device configuration based on the first intelligent device information and to configure the second intelligent industrial device 102 based on the second intelligent industrial device configuration.

In various examples, the mobile device 120 with an app, upon connecting to the industrial system 100 (e.g., via a HIM 110, 136, the WAP 106 and/or via the cloud connection 108 and cellular communications) can clone an intelligent industrial device 102 and backup (store) the device configuration and any other suitable information by which a clone of the first intelligent industrial device 102 can be created in a second industrial device 102, whether of the same or a different type. This facilitates cloning for replacement and/or replication in the industrial system 100. In certain examples, the mobile device 120 can do a backup of the first intelligent industrial device 102, including information about one or more of serial number, part number, and device configuration and the mobile device 120 can create a clone of first intelligent industrial device 102, including downloading the same firmware version and the same application to another (e.g., a second) intelligent industrial device 102, for example, to implement replacement for repair (e.g., a failed device) and or replacement for replication. The clone configuration can be stored to, and delivered locally or from the cloud 108, and the mobile device 120 can trigger or otherwise initiate the storage and/or downloading as an interface.

The mobile device 120 can manage conversion or cloning between drives or other intelligent industrial devices 102 of different types. The mobile device 120 can implement an intelligent industrial device interface language, such as a drive interface language with a description of functionality for each device type and deploy that across a wide range of target product catalogs that support those capabilities. The mobile device 120 can obtain a device ID object 130 from an intelligent industrial device 102, the controller 104, and/or the cloud-based server 109 and create a description of functionality of the first intelligent industrial device 102 based on the device ID object 130 and the device configuration and store the functional description to the cloud-based server 109. The mobile device 120 can obtain a second device ID object 130 from the second intelligent industrial device 102 and can convert the description of functionality (e.g., from the cloud backup) to a second device configuration suitable for the second intelligent industrial device 102 to create a functional clone even if the intelligent industrial devices 102 are different (e.g., different motor drive types). In one or more examples, the mobile device 120 obtains and uses additional information to create a clone, such as functionality object revisions, serial numbers, firmware versions, frame sizes for support, etc. In certain example, moreover, the mobile device 120 can present a common functional view of an intelligent industrial device 102 to a user, for example, as a high level functional definition including graphical and/or textural renderings (e.g., on the touch screen 121 of the mobile device 120). The mobile device 120 in certain examples can translate parameter numbers to create a clone in a different type intelligent industrial device 102.

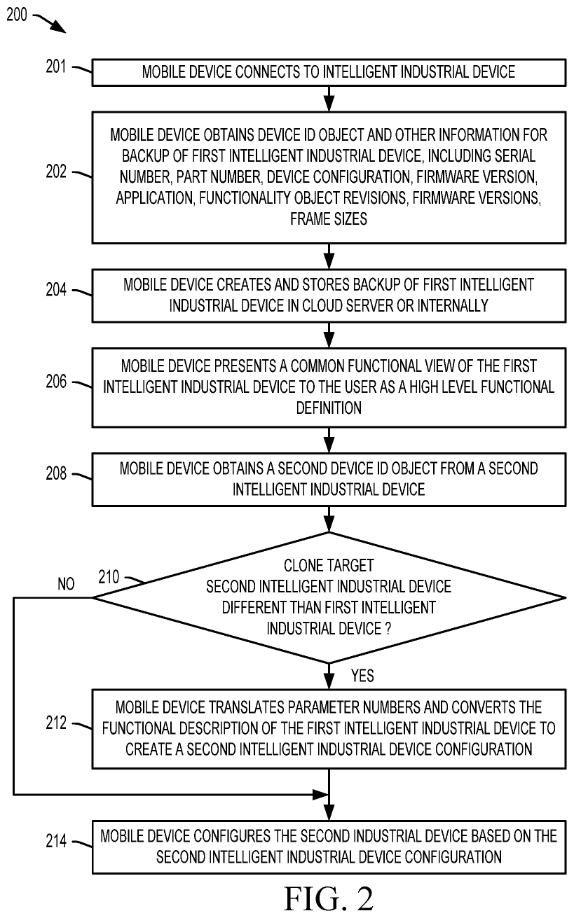

FIG. 2 shows a method 200 that can be implemented, in whole or in part, using the mobile device 120 and the industrial system 100 in one example. At 201 in FIG. 2, the mobile device 120 is configured with suitable program instructions (e.g., program 125 in FIG. 1B above) and establishes a communications connection to a first intelligent industrial device 102 of the industrial system 100 via the industrial network 101.

At 202, the mobile device 120 obtains first intelligent device information for backup of the first intelligent industrial device 102 of the industrial system 100, for example, a device ID 130 corresponding to the first intelligent industrial device 102. The first intelligent device information can be obtained from any suitable source within the industrial system 100, including from the first intelligent industrial device 102 itself, from another intelligent industrial device 102 of the system, from the controller 104, from the cloud-based server 109, etc. In one example, the first intelligent device information obtained at 202 includes one or more device IDs 130, one or more of a serial number, a part number, a device configuration, a firmware version, and application, a functionality object revision, a firmware version, and a frame size, etc.

At 204, the mobile device 120 creates a backup of the first intelligent industrial device 102 including a first device identity and a first device configuration based on the first intelligent device information. In this or another example, the mobile device 120 stores the backup of the first intelligent industrial device 102, for example, internally and/or to the cloud-based server and/or to another suitable memory location of the industrial system 100.

In one example at 206 in FIG. 2, the mobile device 120, presents a common functional view of the first intelligent industrial device 102 as a high level functional definition to a user. In this or another example, the mobile device 120 stores the high level functional definition at 204, for example, internally and/or to the cloud-based server and/or to another suitable memory location of the industrial system 100.

In the above or other examples, the mobile device 120 obtains second intelligent device information for a second intelligent industrial device 102 of the industrial system 100, for example, a second device ID 130 corresponding to the second intelligent industrial device 102. The second intelligent device information can be obtained from any suitable source within the industrial system 100, including from the second intelligent industrial device 102 itself, from another intelligent industrial device 102 of the system, from the controller 104, from the cloud-based server 109, etc. In one example, the second intelligent device information obtained at 202 includes one or more device IDs 130, one or more of a serial number, a part number, a device configuration, a firmware version, and application, a functionality object revision, a firmware version, and a frame size, etc. of the second industrial device 102.

At 210 in FIG. 2, the mobile device 120 determines whether the clone target second intelligent industrial device 102 is different than the first intelligent industrial device 102. If so (YES at 210), the mobile device 120 creates a second intelligent industrial device configuration at 212 based on the high level functional definition, such as by generating configuration parameters for the second intelligent industrial device 102 by converting the high level functional definition and/or the mobile device 120 converts the configuration parameters of the first device configuration at 212 to create the second intelligent industrial device configuration, for example, based on a predetermined mapping between configuration parameters of the first and second intelligent industrial devices 102, which may be different but suitably equivalent. In these or other examples, the mobile device 120 can create the second intelligent industrial device configuration based on the first intelligent device information. The mobile device 120 in one example can implement a conversion from the configuration of one intelligent industrial device 102 to the other, for example, setting the second intelligent industrial device 102 up to function in the same manner, including use of parameters of the second intelligent industrial device 102 that are converted by the mobile device 120 based on differences between the intelligent industrial devices 102. One example includes transferring the process settings from one drive to another when the two drives are controlling motors of different ratings, where the conversion tool implemented by the mobile device 120 includes the intelligence to know that process settings (e.g., the source of a speed reference, or the source of start/stop commands) could be the same even though the motor parameters are different between the two drives.

At 214 in FIG. 2, the mobile device 120 configures the second intelligent industrial device 102 based on the second intelligent industrial device configuration. In one example, the mobile device 120 configures the second intelligent industrial device 102 as a clone of the first intelligent industrial device 102 at 214 based on the backup.

Various embodiments have been described with reference to the accompanying drawings. Modifications and changes may be made thereto, and additional embodiments may be implemented, without departing from the broader scope of the invention as set forth in the claims that follow. The specification and drawings are accordingly to be regarded in an illustrative rather than restrictive sense. The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

1. A computer-implemented method for cloning intelligent industrial devices, the method comprising:
obtaining, by a mobile device, first intelligent device information for backup of a first intelligent industrial device of an industrial system;
creating, by the mobile device, a backup of the first intelligent industrial device including a first device identity and a first device configuration based on the first intelligent device information;
determining, by the mobile device, that a second intelligent industrial device has a different device type than the first intelligent industrial device;
converting, by the mobile device, the first device configuration to a second device configuration for the second intelligent industrial device, wherein the converting is based on a predetermined mapping between the first intelligent industrial device and the second intelligent industrial device; and
transmitting, by the mobile device, the second device configuration to the second intelligent industrial device to create a clone of the first intelligent industrial device.

2. The method of claim 1, further comprising:
storing, by the mobile device, the backup of the first intelligent industrial device.

3. The method of claim 1, wherein the first intelligent device information includes one or more of a serial number, a part number, a device configuration, a firmware version, an application, a functionality object revision, a firmware version, and a frame size.

4. The method of claim 1, further comprising:
presenting, by the mobile device, a common functional view of the first intelligent industrial device as a high level functional definition to a user.

5. The method of claim 4, further comprising:
storing, by the mobile device, the high level functional definition.

6. The method of claim 1 further comprising:
obtaining, by the mobile device, second intelligent device information associated with the second intelligent industrial device, wherein the determining that the second intelligent industrial device has the different device type is in response to the obtaining the second intelligent device information.

7. The method of claim 6, wherein the second intelligent device information includes one or more of a serial number, a part number, a device configuration, a firmware version, an application, a functionality object revision, a firmware version, and a frame size.

8. The method of claim 6, wherein the converting comprises translating parameter numbers of the first device configuration to create the second device configuration.

9. A non-transitory computer readable medium having computer executable instructions which, when executed by a processor of a mobile device connected to an industrial network of an industrial system, cause the mobile device to:
obtain first intelligent device information for backup of a first intelligent industrial device of the industrial system;
create a backup of the first intelligent industrial device including a first device identity and a first device configuration based on the first intelligent device information;
determine that a second intelligent industrial device has a different device type than the first intelligent industrial device;
convert the first device configuration to a second device configuration for the second intelligent industrial device, wherein the converting is based on a predetermined mapping between the first intelligent industrial device and the second intelligent industrial device; and
transmit the second device configuration to the second intelligent industrial device to create a clone of the first intelligent industrial device.

10. The non-transitory computer readable medium of claim 9, having computer executable instructions which, when executed by the processor, cause the mobile device to store the backup of the first intelligent industrial device.

11. The non-transitory computer readable medium of claim 9, wherein the first intelligent device information includes one or more of a serial number, a part number, a device configuration, a firmware version, an application, a functionality object revision, a firmware version, and a frame size.

12. The non-transitory computer readable medium of claim 9, having computer executable instructions which, when executed by the processor, cause the mobile device to present a common functional view of the first intelligent industrial device as a high level functional definition to a user.

13. The non-transitory computer readable medium of claim 12, having computer executable instructions which, when executed by the processor, cause the mobile device to store the high level functional definition.

14. The non-transitory computer readable medium of claim 9, having computer executable instructions which, when executed by the processor, cause the mobile device to:
obtain second intelligent device information associated with the second intelligent industrial device, wherein the determining that the second intelligent industrial device has the different device type is in response to the obtaining the second intelligent device information.

15. The non-transitory computer readable medium of claim 14, wherein the second intelligent device information includes one or more of a serial number, a part number, a device configuration, a firmware version, an application, a functionality object revision, a firmware version, and a frame size.

16. The non-transitory computer readable medium of claim 14, wherein the converting comprises translating parameter numbers of the first device configuration to create the second device configuration.

17. A mobile device, comprising:
a memory that stores executable components; and
a processor, operatively coupled to the memory and configured to execute the executable components, the executable components comprising:
a communications component that communicates with intelligent industrial devices of an industrial system;
a backup component that creates a backup of a first intelligent industrial device including a first device identity and a first device configuration;
a determination component that determines that a second intelligent industrial device has a different device type than the first intelligent industrial device;
a conversion component that converts the first device configuration to a second device configuration suitable for the second intelligent industrial device, wherein the converting is based on a predetermined mapping between the first intelligent industrial device and the second intelligent industrial device; and
a transmitting component that transmits the second device configuration to the second intelligent industrial device to create a clone of the first intelligent industrial device.

18. The mobile device of claim 17, configured to present a common functional view of the first intelligent industrial device as a high level functional definition to a user.

19. The mobile device of claim 18, configured to store the high level functional definition.

20. The mobile device of claim 18, wherein the converting comprises translating parameter numbers of the first device configuration to create the second device configuration.
